(19) United States
(12) Patent Application Publication
(10) Pub. No.: US 2008/0126218 A1
(43) Pub. Date: May 29, 2008

(54) SYSTEM AND METHOD FOR PROVIDING SHIPPING SERVICES

(75) Inventors: Wiliam A. Alvarado, Menlo Park, CA (US); Anselm Baird-Smith, San Jose, CA (US); Raymond Walsh, San Jose, CA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: LA LA MEDIA, INC., Palo Alto, CA (US)

(21) Appl. No.: 11/770,362

(22) Filed: Jun. 28, 2007

Related U.S. Application Data
(60) Provisional application No. 60/806,044, filed on Jun. 28, 2006.

(51) Int. Cl. G06Q 30/00; G06Q 20/00; G06Q 10/00

(52) U.S. Cl. 705/26; 705/44; 705/1

(57) ABSTRACT

Shipping costs are managed in a process wherein a plurality of entities who possess articles ship the articles via a mail system to a plurality of entities who receive the articles. A database is maintained of articles and article attributes. For each shipped article, the shipment control entity receives information that an entity who possesses an article will ship the article via the mail system to an entity who will receive the article. The shipment control entity is unrelated to any of the article possessing or article receiving entities. Also, for each shipped article, article shipping costs is determined based at least on one or more of the article attributes obtained from the database, and payment to the mail system is initiated based on the article shipping costs. Article attributes include the weight of the articles and ancillary items associated with the article.

### CROSS REFERENCE TO RELATED APPLICATION

This application claims the benefit of U.S. Provisional Patent Application No. 60/806,044 filed Jun. 28, 2006.

### BACKGROUND OF THE INVENTION

1. Field of the Invention

Embodiments of the present invention relate to systems and methods for providing shipping services. More particularly, embodiments of the present invention relate to providing shipping services to individuals and entities from a central service provider.

2. Background Information

For years, direct mailers, internet sites, and other entities have utilized mail to interact with consumers for commerce or communication purposes. These companies utilize a number of mail pieces and products that pay for mail sent to or received from their consumers. In all these cases, the products are designed to be sent from a company location(s) to consumers (one to many, e.g. Imprint Mail) or from consumers back to a company location(s) (many to one, e.g. is Business Reply Mail).

The advent of the Internet has created a new commerce opportunity between individuals transacting directly with each other. Internet businesses play a role in this type of commerce by matching buyers with sellers. However, once the transaction has been agreed upon, sellers and buyers are typically responsible for coordinating the logistical aspects of exchanging the product or service that was paid for. For example, once items from an individual are ordered, the individual is generally responsible for preparing envelopes for the items, weighing the items, calculating the amount of postage required for each item, and affixing the postages or making payment for the cost of shipping the items to various buyers.

### BRIEF SUMMARY OF THE INVENTION

Systems or methods may be provided enable the mailing of items between individuals or entities where shipping arrangements and/or payments for shipping costs may be managed or made by a central entity on behalf of the individuals or entities.

### BRIEF DESCRIPTION OF THE DRAWINGS

The above summary, as well as the following detailed description of preferred embodiments of the invention, will be better understood when read in conjunction with the following drawings. For the purpose of illustrating the invention, there is shown in the drawings an embodiment that is presently preferred, and an example of how the invention is used in a real-world project. It should be understood that the invention is not limited to the precise arrangements and instrumentalities shown. In the drawings:

FIG. 1 is a combined schematic block diagram and flowchart for providing shipment services in accordance with a first embodiment of the present invention.

FIG. 2 is a flowchart for providing shipment services in accordance with a second embodiment of the present invention.

FIG. 3 shows an image of a front view of a sample envelope for shipping articles in accordance with preferred embodiments of the present invention.

FIGS. 4-5 show user interface display screens for use with preferred embodiments of the present invention.

FIG. 6 is a self-explanatory entity diagram of the shipping control entity for use with preferred embodiments of the present invention.

FIGS. 7-10 are database table descriptions for the shipping control entity in accordance with preferred embodiments of the present invention.

FIGS. 11A-11B, taken together, and

FIGS. 12A-12B, taken together, show a Manifest File Format Specification for use with preferred embodiments of the present invention.

FIG. 13 is a sample listing of manifests.

FIG. 14 is a self-explanatory high level hardware architecture for implementing the shipping process in accordance with preferred embodiments of the present invention.

### DETAILED DESCRIPTION OF THE INVENTION

Certain terminology is used herein for convenience only and is not to be taken as a limitation on the present invention.

The present invention is described in the context of preferred embodiments of a web-based software application for music trading commercialized on the World Wide Web at lala.com, and described in part in copending U.S. application Ser. No. 11/682,635 filed Mar. 6, 2007 entitled “Article Trading Process,” which is incorporated by reference in its entirety. Lala.com is a service of la la media, inc., Palo Alto, Calif. However, the scope of the present invention is not limited to this particular implementation of the invention. The present invention is described in the context of a plurality of distributed computers, all of which are linked together by an electronic network, such as the Internet. The computers may be any type of computing device that allows a user to interact with a web site via a web browser. For example, the computers may be personal computers (PC) that run a Microsoft Windows® operating system. The computers may also be handheld, wireless devices.

### I. DEFINITIONS

The following definitions are provided to promote understanding of the present invention.
article: an article is an item or commodity. An article can be in “tangible” form or can initially be in “intangible” form, but can be put in tangible form when shipped by an entity who possesses the article, such as when shipped in conjunction with trade activity. For example, a member of the community may possess an article such as a music recording, video presentation, or printed material such as a book in electronic form only, along with rights to copy the article into a tangible form such as onto a portable electronic medium (e.g., CD, DVD) or paper, as well as the rights to transfer the article to another person. This type of intangible article can be shipped and traded in its tangible form.
own: ownership as used herein includes full ownership rights conveyed in accordance with the “first sale doctrine” (discussed below). Ownership also includes ownership of a limited use license (e.g., based on time, playback amounts). For example, an entity who possesses an article may ship articles as part of article trade activity wherein the articles convey only the remaining license rights which would be communicated to the receiving entity.
administration computer: a computer or processor that administers the shipping control entity, and optionally, the trading platform for the members. The administration computer may be a single computer or a network of computers, such as a server or network of servers.

### II. OVERVIEW

In one preferred embodiment of the present invention, articles are traded among a plurality of members registered in a common community using a computer-implemented process. Each member has an account that includes a trading credit balance and a mailing address. A user interface allows a member to enter articles that the member possesses (and usually also owns), and is willing to trade, and articles that the member wants to receive (and usually also own). The user interface also allows the member to receive article trading instruction messages. An electronic network, such as the Internet, is used to communicate between the user interface and an administration computer that is associated with the community. The administration computer hosts the plurality of members and facilitates article trades among the members via the electronic network. The administration computer identifies matches between possessed and wanted articles. For each identified match, the administration computer sends an article trading instruction message to the article possessor notifying the article possessor that the article is requested. If the article possessor agrees to send the article, the article possessor is provided with the mailing address of the member who wants to receive the article. The administration computer then posts a trading credit to the member's account who agreed to send the article and posts a trading debit and a monetary charge to the member's account who will be receiving the article.

Each trading credit entitles a particular member to receive one article from any other member who is not necessarily a member that the particular member sent articles to. That is, the article trades are one-way article trades and members do not trade directly with each other. In one scheme, traded articles are all of the same type (e.g., audio compact discs (CDs), such as CDs containing musical recordings; audio recordings on other forms of computer-readable media). In alternative embodiments of the present invention, the articles may be of different types, such as books, CDs, and digital video discs (DVDs). That is, one type of article may be traded for another type of article.

Regardless of the types of traded articles or the details of the trading credits, each of the trades requires one member to send an article to another member. To facilitate the trading process, members are provided with postage-paid mailing envelopes and article cases so as to allow the members to mail articles that the members possess to other members of the common community as part of the article trading process. The envelopes have no addressee printed thereon. The members are instructed by the administration computer as to who the addressee should be when a match is located.

The present invention provides a process to facilitate payment for the envelope mailing through the U.S. Postal Service which had no prior mechanism to track and receive postage due from mailing envelopes sent between members of such a community. The present invention may also be used for facilitating payment for any type of package delivery between two different entities.

In this detailed description, for purposes of explanation, numerous specific details are set forth to provide a thorough understanding of embodiments of the present invention. One skilled in the art will appreciate, however, that embodiments of the present invention may be practiced without these specific details. Furthermore, one skilled in the art can readily appreciate that the specific sequences in which the methods are presented and performed are illustrative and it is contemplated that the sequences can be varied and still remain within the spirit and scope of embodiments of the present invention.

The present invention provides systems and methods for providing shipping services. In some examples, systems and/or methods are provided to enable the shipping or mailing of items between individuals or entities where shipping arrangements and/or payments for shipping costs may be managed or made by a central entity on behalf of the individuals or entities. In some examples, the items may be mailed or shipped using standard packages or envelopes.

In examples consistent with the invention, an integrated shipment and payment solution may be provided for individuals to mail each other directly products of varying weights, shapes, and sizes to a number of destinations, including both domestic and international ones, using one or more mail carriers.

### III. FIRST EMBODIMENT

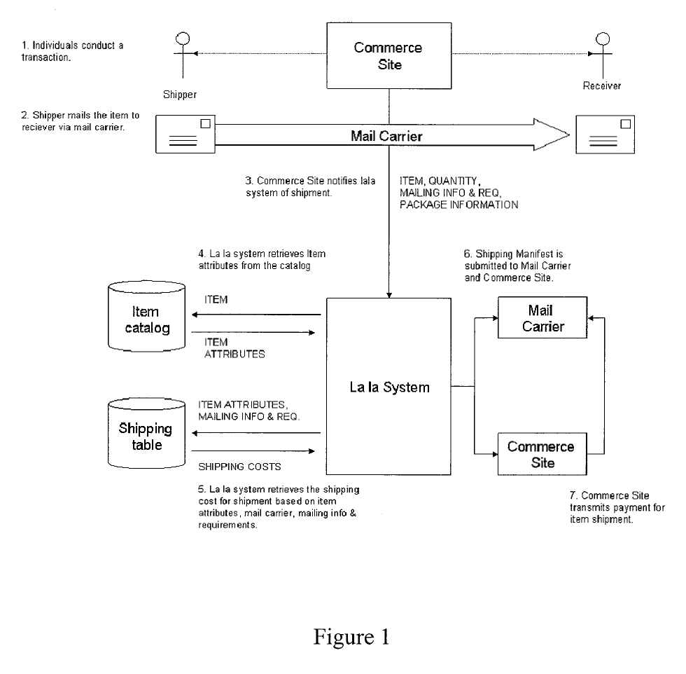

FIG. 1 illustrates an exemplary block diagram for a system that provides shipment services and also an exemplary process flow for providing shipment services.

Referring to FIG. 1, a system for providing shipping services, such as a system circulated by the dash lines in FIG. 1, may be coupled with a device operated by one or more individuals or one or more entities, including one or more entities that operate commerce sites, online or over the Internet. The device or those individual or entities may provide information concerning the items to be shipped, such as the commercial name, identification, bar code, or other descriptions of each item. A system for providing shipping services may also be coupled with a device operated by one or more mail carriers or other carriers that are capable of shipping the items. As an example, the system for providing shipping services may have a processor, such as the “La la System” shown, and one or more databases coupled to the processor for providing, managing, or storing information. In one example, databases such as an Item catalog and Shipping table may be included. In some examples, the shipping service system may be implemented with a computer system with a central processing unit and one or more associated storage devices, such as a memory device or a hard drive.

Referring to FIG. 1, in one example, individuals or entities may agree to conduct a transaction for an item via a Commerce Site at step 1. The transaction may require that one individual or entity, the Shipper, mail one or more item(s) to the other individual or entity, the Receiver. At step 2, the Shipper may mail or send the item to the Receiver via a carrier, such as the Mail Carrier shown. In one example, the Shipper, the Receiver or the Commerce Site may notify the processor (La la system, for example) of the transaction and/or the need for shipment between the individuals, such as what is shown at step 3. In some examples, the transaction may originate from a commerce site managed by the processor itself or a third party.

In one example, the transaction or shipment information may include, but is not limited to, one or more of the following items: (a) Item Identifier (e.g., a CD, a Book, a commercial item, etc.); (b) the Item Quantity to be mailed; (c) Mailing Information such as carrier, origination address, and destination address; (d) Delivery Requirements for the item (e.g. next day delivery, delivery confirmation, shipping insurance, etc.); (e) an item or transaction identifier or a unique identifier for the package used by a shipper to mail the item via a particular carrier; (f) some other information a particular system or carrier may need for providing shipping services.

Referring to FIG. 1, at step 4, the shipping service system (La la system, for example) may use the item identifier to search an Item Catalog Database to retrieve the relevant Item Mailing Attributes for the item. As an example, the item Mailing Attributes may include, but are not limited to weight, shape, size, product's market value or manufacturer's suggested price. At step 5, the shipping service system may use one or more of the Item Mailing Attributes, the Mailing Address Information, and the Transaction Mailing Requirements to calculate the shipping cost for the item(s) by referencing the Shipping Database. Other cost associated with the shipping, such as insurance or service fee, may also be calculated. At step 6, the shipping service system may record the transaction and transmits the information, such as a manifest record, in real-time or batch format, to the Commerce Site and the Mail Carrier.

At step 7, a payment information, such as payment routine, invoice, or request, in real-time or batch format, may be initiated for payment of the shipping costs and other costs by the Shipper or by the Commerce Site to the Mail Carrier. In some examples, envelopes or boxes with optional identification information, such as identification number or bar code, may be provided to a shipper without requiring item information or without associating those envelopes or boxes with the shipping of particular items. In other words, a shipper can obtain a number of envelopes or boxes without pre-paying the shipping cost or identifying the item information until the shipper actually use the envelopes or boxes to ship items. When the shipper needs to ship an item, the shipper can then associate the identification information with the particular item, and a carrier or others may use the identification information to track the shipment, verify the shipping terms and conditions, or verify or audit the payment made for the shipping.

In another version of the first embodiment of the present invention, instructions adapted to be executed by a processor to perform methods illustrated above or to implement systems illustrated above may be stored on a computer-readable medium. The computer-readable medium can be a device that stores digital information. For example, a computer-readable medium includes a read-only memory (e.g., a Compact Disc-ROM (“CD-ROM”) or DVD) as is known in the art for storing software. The computer-readable medium can be accessed by a processor suitable for executing instructions, which may be any instructions that are ready to be executed in their present form (e.g., machine code) by a processor, or require further manipulation (e.g., compilation, decryption, or provided with an access code, etc.) by a processor or some other devices to be ready to be executed by a processor.

To summarize, the first embodiment provides the following systems and methods:
1. A system for providing shipping services to individuals or entities from a central service provider that manages the shipping conditions and payment of shipping cost on behalf of a shipper.
2. A system for enabling the mailing of items between individuals or entities where the items are mailed using standard packages or envelopes or labels, and payment for such mailings is managed or made by a central entity on behalf of the individuals.
3. A system for providing shipping services that includes a first device for receiving item information relating to an item to be shipped, a second device for retrieving shipping information from one or more databases based on the item information, a third device for providing the shipping information to a carrier, and a fourth device for receiving a payment for a shipping service of the item.
4. A method for providing shipping services that operates as follows:
(a) Receive item information relating to an item to be shipped.
(b) Retrieve shipping information from one or more databases based on the item information.
(c) Provide the shipping information to a carrier, such as via a website handling a transaction related to the item.
(d) Receive a payment for shipping service of the item, directly or indirectly, from a shipper, and/or receive a payment request, directly or indirectly from the carrier.
(e) Arrange for the shipment of the item from a shipper through a carrier.
(f) Provide shipment identification information and receive the item information in association with the shipment identification information.

The shipment identification information preferably comprises an identification number identified with an envelope or a box, and at least one of the following items: an item attribute from an item catalog, a shipping cost based on the item attribute, a shipping cost based on the item information, a carrier information, shipping information, and shipping requirements.

### IV. SECOND EMBODIMENT

### A. Overview

Shipping costs are managed in a process wherein a plurality of entities who possess articles ship the articles via a mail system to a plurality of entities who receive the articles. A database is maintained of articles and article attributes. The process operates as follows:
1. For each shipped article, the shipment control entity receives information that an entity who possesses an article will ship the article via the mail system to an entity who will receive the article. The shipment control entity is a different entity than any of the article possessing or article receiving entities.
2. For each shipped article, article shipping costs are determined based at least on one or more of the article attributes obtained from the database.
3. For each shipped article, payment is initiated to the mail system based on the article shipping costs determined above.

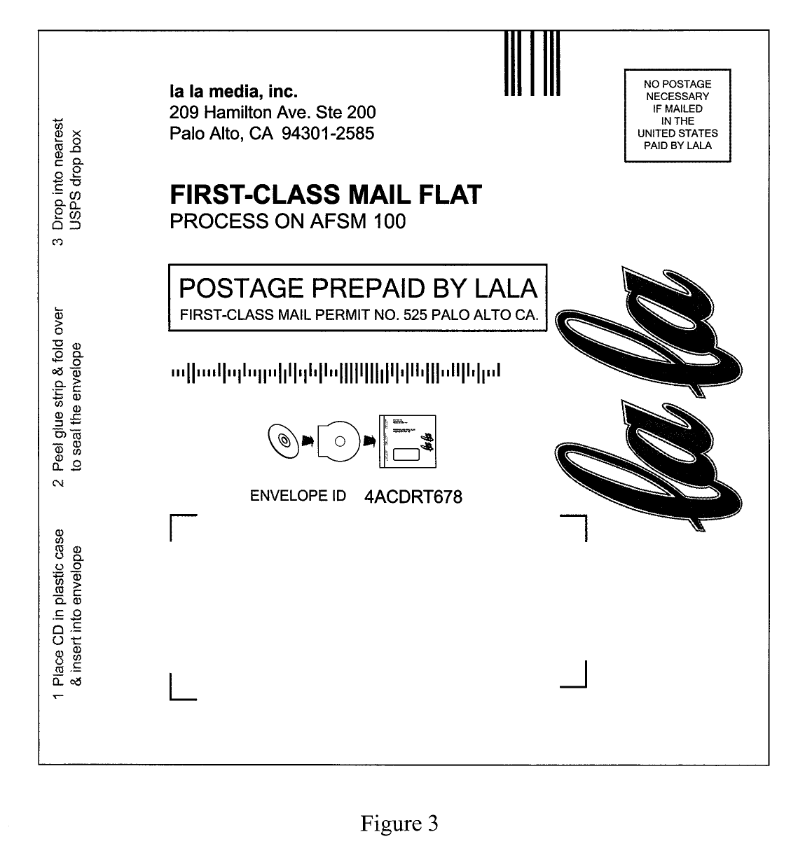

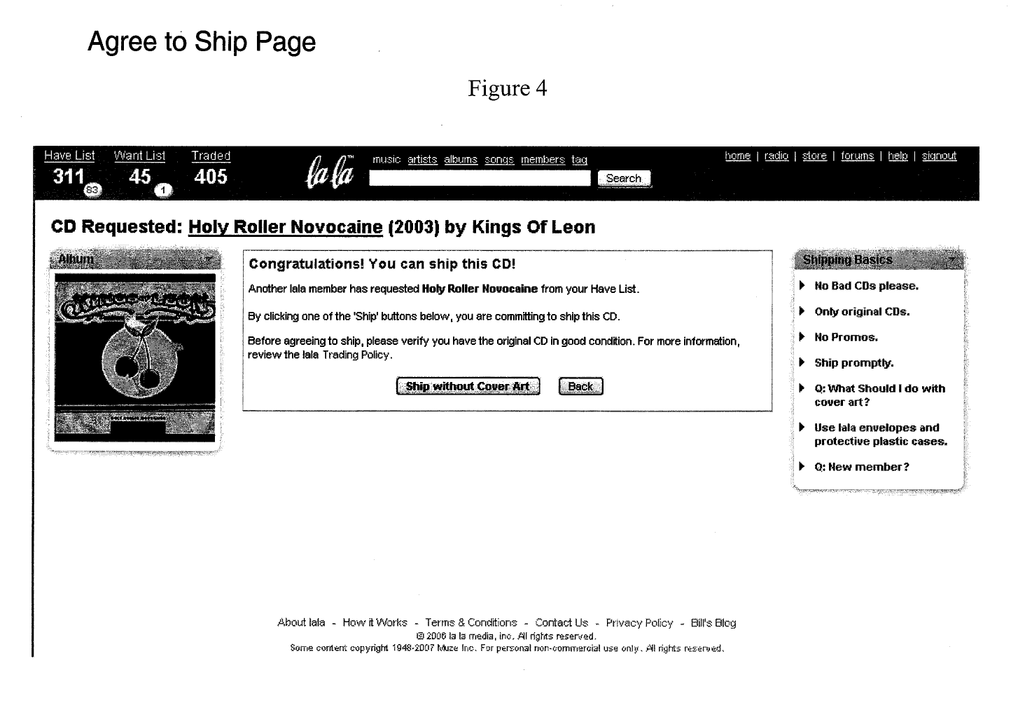

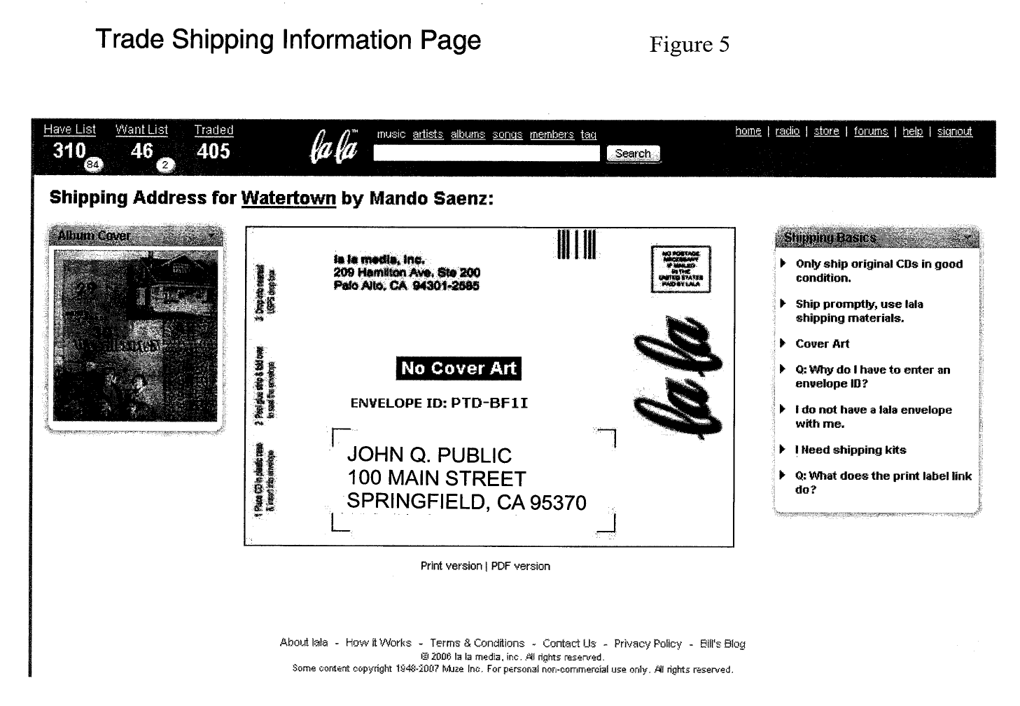

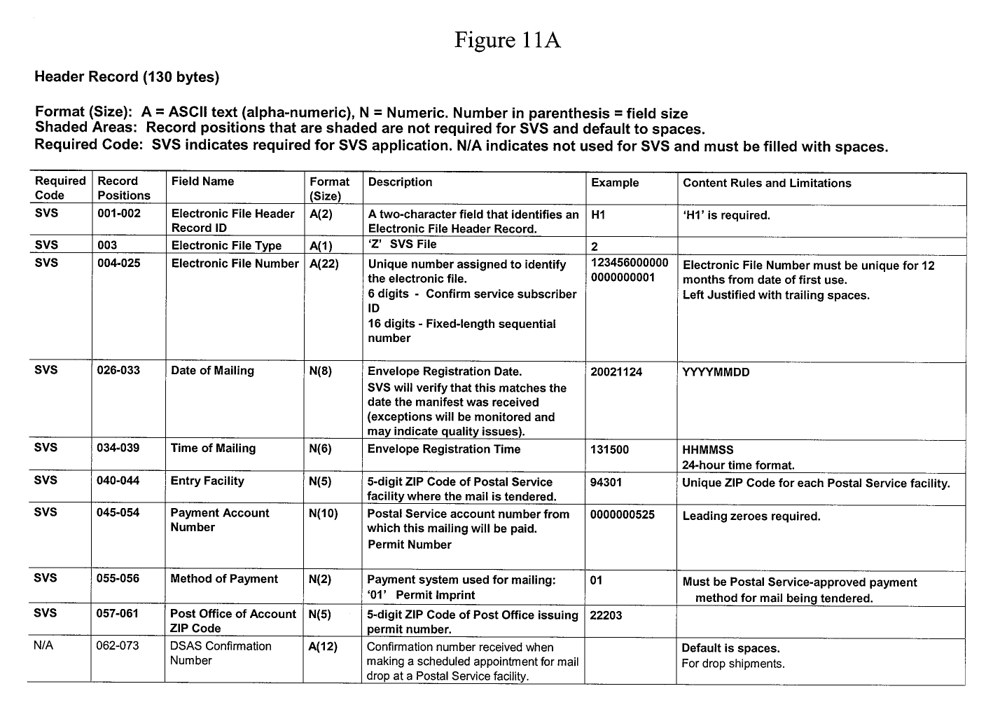

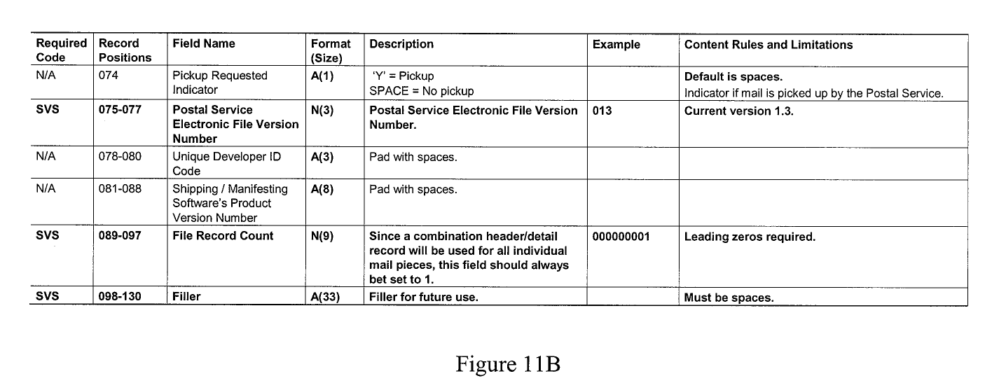

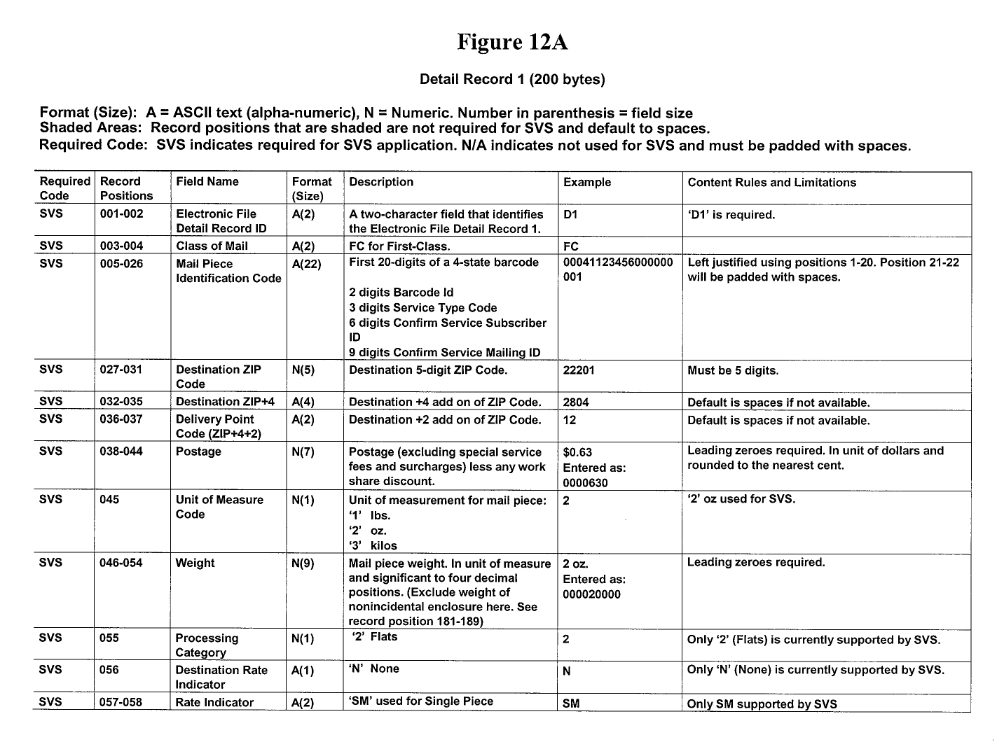

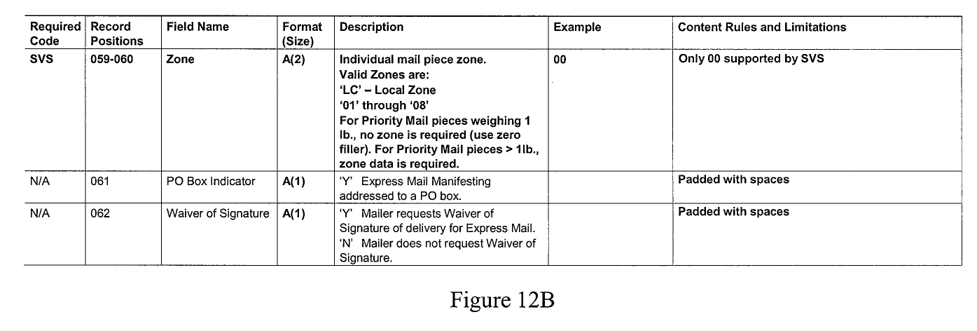

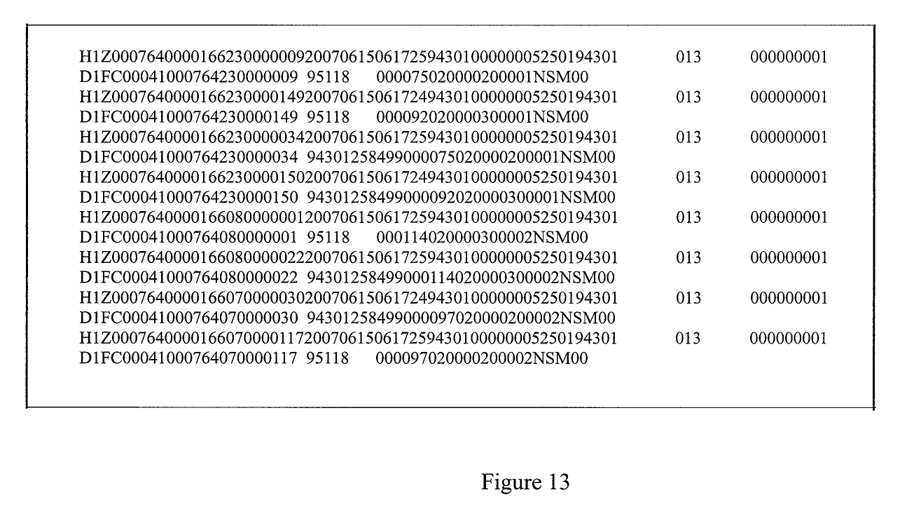

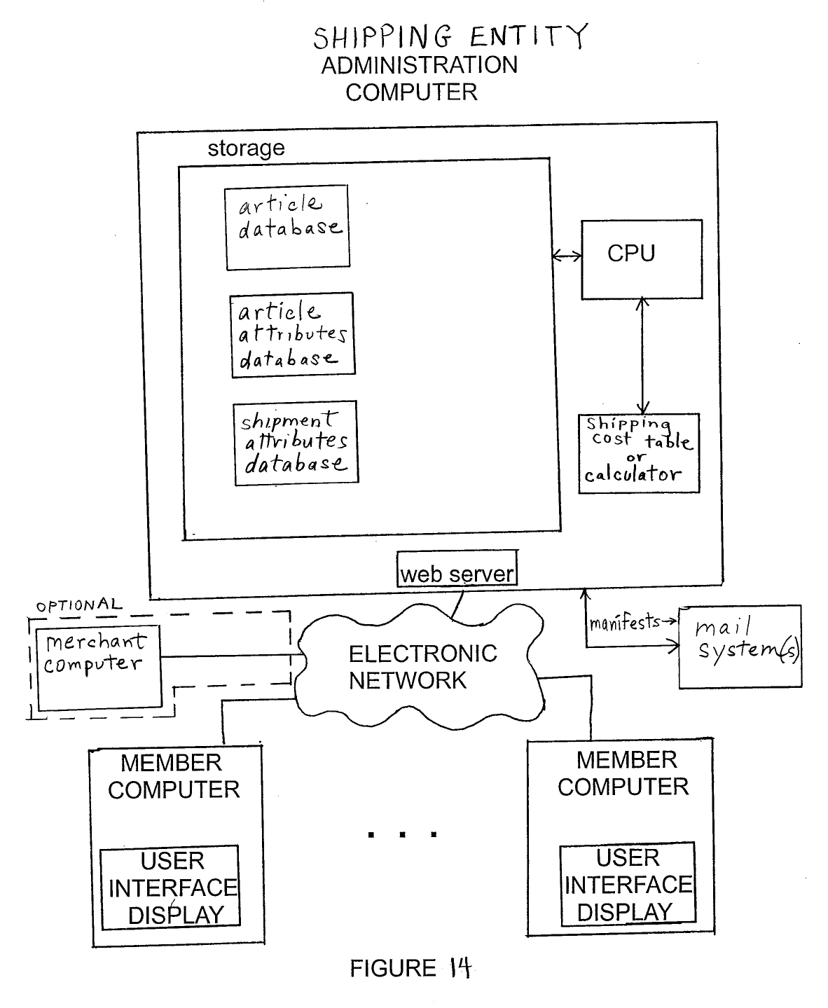

Alternative versions of this second embodiment are described below.
1. The shipment control entity further maintains a database of shipment attributes. The article shipping costs are then based at least on one or more of the article attributes and one or more of the shipment attributes obtained from the database. The shipment attributes may include the distance between the entity who possesses and will ship the article and the entity who will receive the article, the postal classification (e.g., First Class Mail, Priority Mail, etc., if using the U.S. Postal Service (USPS) Classification), the type of mail system used (e.g., USPS, FedEx, DHL), and packaging characteristics (e.g., size and/or shape of shipping envelope or box). The entity that possesses and will ship the article communicates one or more of the shipment attributes to the shipment control entity for use by the shipment control entity in determining the article shipping costs. For example, if an article is a CD, one of the shipment attributes will be whether or not the CD is shipped with its cover art since the weight of the cover art will typically affect the total shipping costs when using USPS First-Class Mail rates.
2. Each article shipment preferably includes a unique identification (ID) number. The shipment control entity receives the unique ID number for each shipped article from the entity who possesses and will ship the article. The shipment control entity then communicates the unique ID number for each shipped article to the mail system via a manifest (one per shipment, described in more detail below) for use by the mail system in auditing articles shipped via the mail system. The articles are preferably shipped in postage-paid mailers and the unique ID numbers are obtained from the mailers. The unique ID numbers may be pre-printed on the mailers, as shown in FIG. 3 (e.g., see the human-readable Envelope ID 4ACDRT678 and the corresponding machine-readable bar code). In addition to, or instead of, the machine-readable bar code, the unique ID number may be hidden within the envelope in data embedded within a conventional RFID tag or the like, which is readable using conventional RFID readers. The RFID tag may have a human-readable ID number pre-printed on it.
3. An article commerce site may be provided that allows entities who possess articles to transact business with entities who desire to receive the articles. The article commerce site communicates completed transactions to the shipment control entity so as to facilitate the shipping of the transacted articles among the entities. The article commerce site and the shipment control entity may be different business entities or may be part of the same business entity. Furthermore, the shipment control entity may be a hosting entity for a plurality of members of a common community that facilitates article trading among the members. In this scenario, the plurality of entities who possess articles to ship and the plurality of entities who receive the articles are all members of the hosting entity. In the lala.com trading platform example, lala.com acts as both the article commerce site and the shipment control entity, as well as acting as the hosting entity.
4. The shipment control entity may send an electronic instruction message to the entity who possesses the article to ship the article to the entity who will receive the article. The electronic instruction message includes a shipping address of the entity who will receive the article. In the lala.com trading platform example, once the entity who possesses the article (here, the CD owner) agrees to ship the article by clicking on a confirmation button “Ship without Cover Art” shown in the display screen in FIG. 4, the recipient's address is provided to the CD owner in the display screen shown in FIG. 5.
5. Shipment costs may be handled in a lot of different ways. For example, the shipment control entity may electronically pay the mail system for the shipping costs. The shipment control entity may then optionally electronically bill the shipping costs to either the entity that shipped the article or the entity that received the article. The payment process may be initiated when an entity who possesses an article agrees to ship the article by sending an electronic message sent to the shipment control entity to that effect. In the lala.com trading platform example, lala.com electronically pays the USPS for expected incurred shipping costs based on the CD's that members indicate that they will ship. A manifest is used for this process, as described below with respect to FIGS. 11A-11B, 12A-12B and 13. Lala.com also pays the shipping costs for any envelopes that are placed in the USPS mail system and identified by the USPS as envelopes that were not previously identified by, and paid for, by lala.com. This may happen in the rare instance that a member sends an envelope to someone without receiving instructions from lala.com to do so. Lala.com recovers some or all of its incurred shipping costs from its trading fee and other business operations, and does not bill members separately for each CD shipment. However, the scope of the invention includes such a direct reimbursement process.
6. The plurality of entities who possess articles may be merchants who have merchant accounts. In this scenario, the shipment control entity may authorize payment to the mail system from the merchant account of the merchant that shipped the article.
7. The article attributes preferably include the weight of the articles, so that at least the article weight is used to determine the article shipping cost. The article attributes may also include ancillary items associated with the article, such as cover art of a CD. For example, the weight of a CD will be different if the cover art is not included in the shipment. The “cost” of an article may also be an article attribute so that more costly articles have higher shipping charges.
8. The mail system may be a government-run postal service (e.g., USPS) or a privately run mail service, such as UPS, FedEx or DHL.
9. A manifest may be created that identifies each shipped article and the respective article shipping costs. The manifest may be periodically communicated to the mail system via an electronic message. The payments would then be initiated based on the article shipping costs listed in the manifests. Lala.com batches and forwards its manifests daily to the USPS to initiate payment. Sample manifests are shown in FIG. 13, and manifest documentation is shown in FIGS. 11A-11B and 12A-12B. In an alternative scenario, the mail system only charges for shipping costs after it detects receipt of a shipped article that matches an article that the shipment control entity is aware of. In this scenario, the shipment control entity periodically (e.g., daily) electronically communicates the article shipping costs to the mail system along with the associated unique identification numbers for the respective shipped articles. The mail system then detects article shipments that include the unique identification numbers. The mailing system then charges the shipment control entity for the article shipping costs previously communicated to it by the shipment control entity. This scenario would be feasible for mail systems that scan and identify 100% of articles that pass through its system. Private mail systems typically operate in this manner. Other permutations of the above-discussed payment scenarios are within the scope of the present invention.
10. To ensure that the ID numbers are unique, the mailing system may authorize a range of unique ID numbers to be used by a particular shipment control entity. The shipment control entity may then perform a check for uniqueness by comparing the ID number entered by the potential shipping entity against its database to ensure that the entered number is within the authorized range and has not yet been used for a previous shipment. In the lala.com trading platform, this guards against data entry errors made by members when confirming that a shipment will be made, as well as printing errors that may have caused two envelopes to receive the same ID number.
11. If there are only a few article attributes and shipping attributes to consider, the shipping costs may be stored in a database table. However, if there are a large number of article attributes and shipping attributes to consider, the shipping costs may be determined by an algorithmic process that factors in each of the attributes according to an algorithm that is agreed upon between the shipment control entity and the mailing system.
12. In the above-described embodiments, the shipment control entity initiates and authorizes shipments, for example, when lala.com detects trading matches among members. However, the scope of the invention includes scenarios wherein an entity independently initiates a shipment to another entity by using a postage-paid envelope with an ID number on it, and may obtain the shipping address without even contacting the shipment control entity. In this scenario, one or more shipment control entities maintain databases of articles and article attributes. The one or more shipment control entities can correlate envelope ID numbers with the respective articles so that shipping costs can be determined and payment can be initiated to the mail system in the same manner as described above.

Example: A person purchases a consumer electronics article, such as digital camera, cell phone, or rechargeable battery, and receives a postage-paid envelope (mailer) with the article packaging for use in returning the article to a repair center if the article breaks or for returning the article for safe disposal. The mailer includes a unique ID number that is maintained in a database of a shipping control entity. The database of the shipping control entity may contain a large number of consumer electronics articles from many different manufacturers. However, the shipping control entity knows which mailers were distributed with their respective articles (e.g., mailers with ID numbers in a certain range that includes ID number 12345ABCDE were distributed with Nokia® cell phones having Model No. N80, mailers with ID numbers in another range that includes ID number 12345NOPQR were distributed with 1 GB Apple® iPod Shuffles, mailers with ID numbers in yet another range that includes ID number 12345ZYWAB were distributed with SONY NP-FM50 Lithium-ion batteries). The shipping entity also knows the respective article attributes, such as their respective weight (with and without accessories and original packaging) and corresponding dimensions. If a consumer needs to return the article, the consumer can locate a mailing address from a website or can call the company to get the address, if it is not already printed on the envelope. The consumer can then mail the article via the mail system without even contacting the shipping control entity. When the mail system detects the article, it electronically communicates the ID number to the shipping control entity, which, in turn, locates the ID number in its database, calculates the shipping costs based on the article attributes, and initiates payment of the shipping costs to the mail system. Alternatively, the person (article owner) may be instructed by the manufacturer to contact the shipping control entity which will provide the shipping address, will verify which article the person is sending (e.g., cell phone without original packaging, cell phone with original packaging, used battery), and will verify and record the ID number so that payment can be made to the mail system either immediately or upon reconciliation with records of the mail system.
13. When the shipping control entity initiates and pre-authorizes the article shipping, the ID number is not a necessary element in the shipping process because its primary purpose is for auditing. For example, if there is a high level of trust between the shipping control entity and the mail system and little or no system abuse by entities who possess envelopes (that is, the envelopes are only used when instructed by the shipping control entity), the mail system may rely solely on the manifests (with shipping costs listed, but with no envelope ID numbers) created by the shipping control entity for payment. This simplifies many of the steps in the process.

### B. Detailed Disclosure

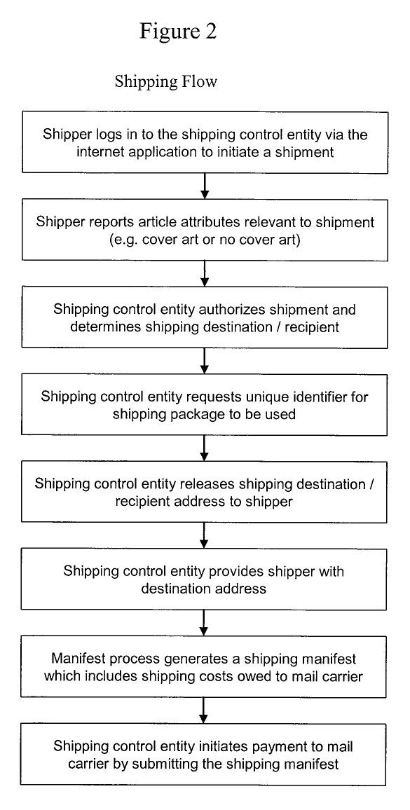

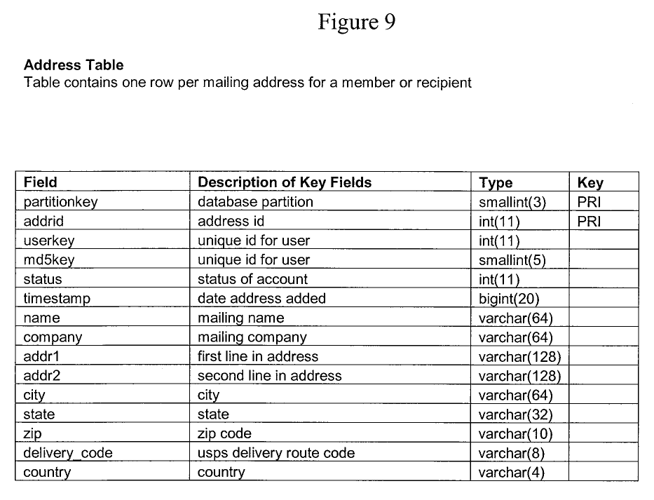

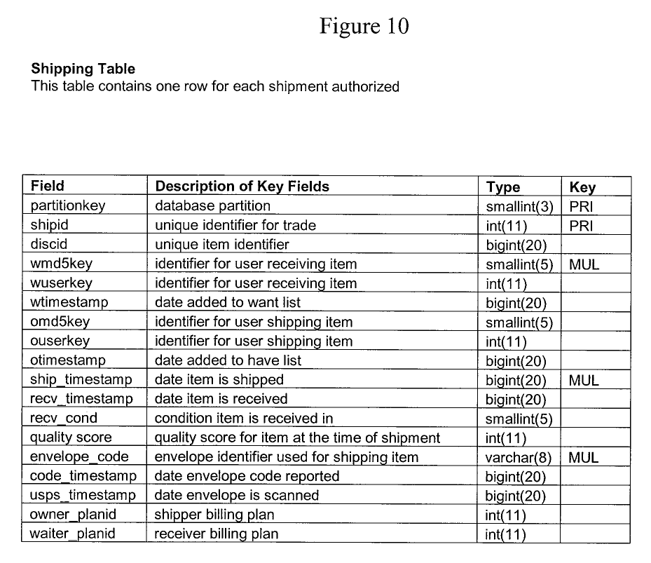

FIGS. 2-13 show details of a sample shipping system used by the lala.com trading platform. However, the present invention is not limited to this example.

FIG. 2 is a self-explanatory flowchart of the shipping process.

FIG. 3 shows an image of a front view of a sample envelope for shipping articles, here CD's. (FIG. 3 is identical to FIG. 39 of U.S. application Ser. No. 11/682,635.)

FIGS. 4-5 show user interface display screens associated with article shipping, namely an “Agree to Ship Page” (FIG. 4) and a “Trade Shipping Information Page” (FIG. 5). (FIGS. 4-5 are identical to FIGS. 21 and 22 of U.S. application Ser. No. 11/682,635.)

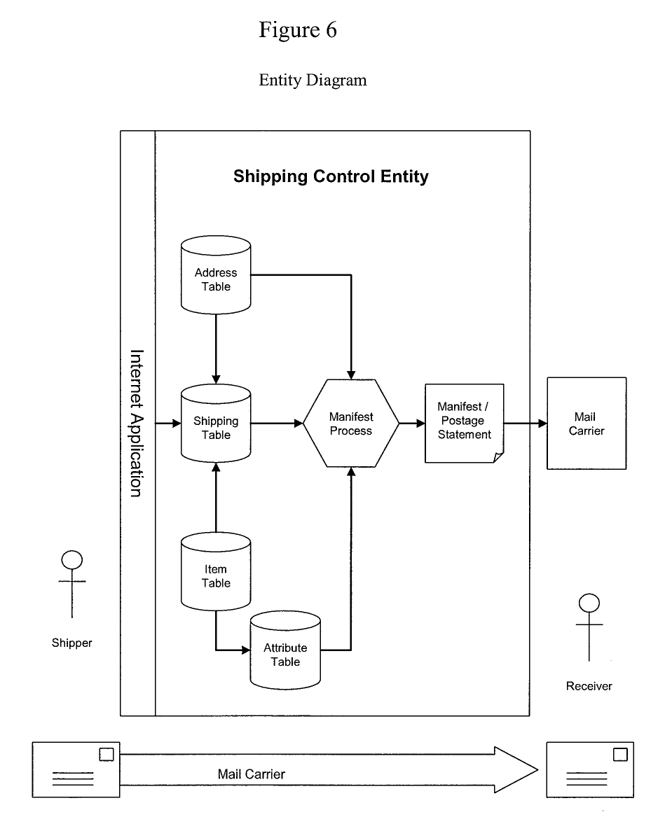

FIG. 6 is a self-explanatory entity diagram of the shipping control entity.

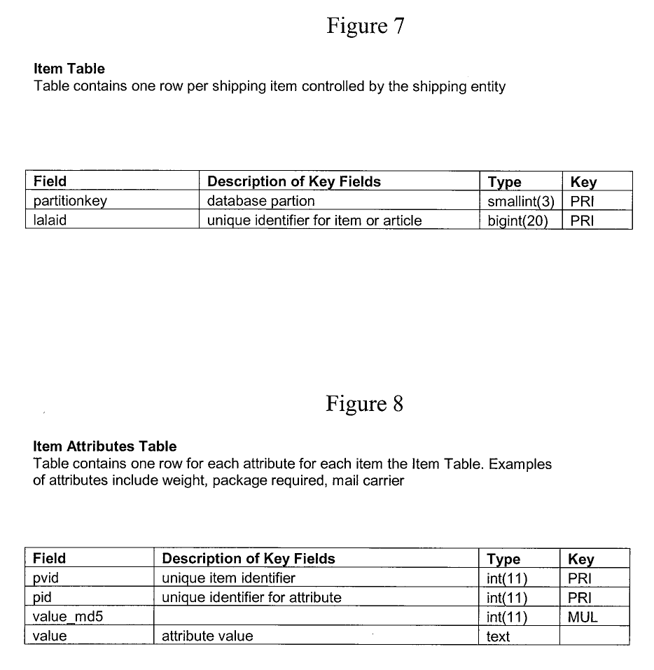

FIGS. 7-10 are self-explanatory database table descriptions for the shipping control entity.

The manifest process generates and submits a manifest to the mail carrier to initiate payment for the shipments authorized by the shipping control entity. The manifest process must include in the manifest one entry for every shipment authorized in the shipping table by the shipping control entity.

As part of the manifest process, an exact shipping cost for each entry is calculated such that payment for the manifest can then be initiated. As an example, below is a cost table implemented by the manifest process for a trading platform:

U.S. Costs - CDs with Clamshell Inserts

| | Flats | Letters |
|---|---|---|
| Cover Art (<3 oz.) | $0.87 | $0.63 |
| No Cover Art (<2 oz.) | $0.63 | $0.39 |

Using the above table, the manifest process can then determine costs for every shipment of CDs with clamshell inserts in the U.S. in the shipping table. The manifest process retrieves the cover art status of the shipment by examining the status field for the entry in the shipping table. The manifest process also maintains a mapping of envelope code ranges to package types (e.g. flats or letters). The envelope code entered by the shipper is stored in the shipping table and can be combined with the cover art status to determine the cost for the shipment.

The manifest process can implement additional cost tables based on destination distance, package types, and many other article or shipment attributes.

FIGS. 11A-11B, taken together, and FIGS. 12A-12B, taken together, show a Manifest File Format Specification, including a Header Record (FIGS. 11A-11B) and a Detail Record (FIGS. 12A-12B). The tables shown in these figures are part of the USPS Publication 91, Confirmation Services Publication Guide, that specifies the electronic file format for confirmation services. The USPS Seamless Verification System (SVS) will use this format for receiving manifest data from lala.com. The description column has been updated for use by the SVS application. A new file type (‘Z’) distinguishes an SVS manifest file from other USPS Product Tracking System (PTS) manifest files.

FIG. 13 is a sample listing of manifests for articles shipped by lala.com members.

FIG. 14 is a self-explanatory high level hardware architecture for implementing the shipping process. The shipping entity administration computer can be the same administration computer shown in FIG. 40 of U.S. application Ser. No. 11/682,635, with the additional elements shown in FIG. 14, namely, the article attributes database, the shipment attributes database, the shipping cost table or calculator, and the additional connection to one or more mail systems that receive the manifests. The member computers in FIG. 14 represent the entities who either have articles to ship or will be receiving articles. However, in the alternative embodiment of the present invention wherein the entities who possess articles are merchants, the member computers represent the entities who will be receiving articles from the merchants.

### V. ADDITIONAL EMBODIMENTS

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1. A computer-implemented method of managing shipping costs in a process wherein a plurality of entities who possess articles ship the articles via a mail system to a plurality of entities who receive the articles, and a database is maintained of articles and article attributes, the method comprising for each shipped article:
(a) the shipment control entity receiving information that an entity who possesses an article will ship the article via the mail system to an entity who will receive the article, wherein the shipment control entity is a different entity than any of the article possessing or article receiving entities;
(b) determining article shipping costs based at least on one or more of the article attributes obtained from the database; and
(c) initiating payment to the mail system based on the article shipping costs determined in step (b).

2. The method of claim 1 wherein the shipment control entity further maintains a database of shipment attributes and step (b) further comprises determining article shipping costs based at least on one or more of the article attributes and one or more of the shipment attributes obtained from the database.

3. The method of claim 2 wherein the shipment attributes include at least one of the following attributes:
(i) the distance between the entity who possesses and will ship the article and the entity who will receive the article,
(ii) the postal classification,
(iii) the type of mail system used, and
(iv) packaging characteristics.

4. The method of claim 2 further comprising:
(d) the entity that possesses and will ship the article communicating one or more of the shipment attributes to the shipment control entity for use by the shipment control entity in determining the article shipping costs.

5. The method of claim 1 wherein each article shipment includes a unique identification number, the method further comprising:
(d) the shipment control entity receiving the unique identification number for each shipped article from the entity who possesses and will ship the article; and
(e) the shipment control entity communicating the unique identification number for each shipped article to the mail system for use by the mail system in auditing articles shipped via the mail system.

6. The method of claim 5 wherein the articles are shipped in postage-paid mailers and the unique identification numbers are obtained from the mailers.

7. The method of claim 5 wherein the unique identification numbers are pre-printed on the mailers.

8. The method of claim 1 further comprising:
(d) providing an article commerce site that allows entities who possess articles to transact business with entities who desire to receive the articles; and
(e) the article commerce site communicating completed transactions to the shipment control entity so as to facilitate the shipping of the transacted articles among the entities.

9. The method of claim 8 wherein the article commerce site and the shipment control entity are part of the same business entity.

10. The method of claim 1 further comprising:
(d) the shipment control entity sending an electronic instruction message to the entity who possesses the article to ship the article to the entity who will receive the article, the electronic instruction message including a shipping address of the entity who will receive the article.

11. The method of claim 1 wherein the shipment control entity is a hosting entity for a plurality of members of a common community that facilitates article trading among the members, and the plurality of entities who possess articles to ship and the plurality of entities who receive the articles are all members of the hosting entity.

12. The method of claim 1 wherein step (c) further comprises the shipment control entity electronically paying the mail system for the shipping costs.

13. The method of claim 1 wherein step (c) further comprises the shipment control entity electronically billing the shipping costs to either the entity that shipped the article or the entity that received the article.

14. The method of claim 1 wherein the articles are compact discs.

15. The method of claim 1 wherein the information in step (a) is an electronic message sent to the shipment control entity by the entity who possesses and will ship the article.

16. The method of claim 1 wherein the plurality of entities who possess articles are merchants who have merchant accounts, and step (c) further comprises the shipment control entity authorizing payment to the mail system from the merchant account of the merchant that shipped the article.

17. The method of claim 1 wherein the article attributes include the weight of the articles, and step (b) includes using at least the article weight to determine the article shipping cost.

18. The method of claim 1 wherein the article attributes include ancillary items associated with the article.

19. The method of claim 1 wherein the mail system is a government-run postal service.

20. The method of claim 1 wherein step (c) further comprises creating a manifest that identifies each shipped article and the respective article shipping costs, and periodically communicating the manifests to the mail system via an electronic message, wherein the payments initiated in step (c) are based on the article shipping costs listed in the manifests.

21. The method of claim 1 wherein each article shipment includes a unique identification number, the method further comprising:
(d) the shipment control entity electronically communicating the article shipping costs determined in step (b) to the mail system along with the associated unique identification numbers for the respective shipped articles; and
(e) the mail system detecting article shipments that include the unique identification numbers, wherein step (c) further comprises the mailing system charging the article shipping costs previously communicated to it in step (d) to the shipment control entity.

22. An article of manufacture for managing shipping costs in a process wherein a plurality of entities who possess articles ship the articles via a mail system to a plurality of entities who receive the articles, and a database is maintained of articles and article attributes, the article of manufacture comprising a computer-readable medium encoded with computer-executable instructions for performing a method comprising for each shipped article:
(a) the shipment control entity receiving information that an entity who possesses an article will ship the article via the mail system to an entity who will receive the article, wherein the shipment control entity is a different entity than any of the article possessing or article receiving entities;
(b) determining article shipping costs based at least on one or more of the article attributes obtained from the database; and
(c) initiating payment to the mail system based on the article shipping costs determined in step (b).

23. The article of manufacture of claim 22 wherein the shipment control entity further maintains a database of shipment attributes and step (b) further comprises determining article shipping costs based at least on one or more of the article attributes and one or more of the shipment attributes obtained from the database.

24. The article of manufacture of claim 23 wherein the shipment attributes include at least one of the following attributes:
(i) the distance between the entity who possesses and will ship the article and the entity who will receive the article,
(ii) the postal classification,
(iii) the type of mail system used, and
(iv) packaging characteristics.

25. The article of manufacture of claim 23 wherein the computer-executable instructions perform a method further comprising:
(d) the entity that possesses and will ship the article communicating one or more of the shipment attributes to the shipment control entity for use by the shipment control entity in determining the article shipping costs.

26. The article of manufacture of claim 22 wherein each article shipment includes a unique identification number and the computer-executable instructions perform a method further comprising:
(d) the shipment control entity receiving the unique identification number for each shipped article from the entity who possesses and will ship the article; and
(e) the shipment control entity communicating the unique identification number for each shipped article to the mail system for use by the mail system in auditing articles shipped via the mail system.

27. The article of manufacture of claim 26 wherein the articles are shipped in postage-paid mailers and the unique identification numbers are obtained from the mailers.

28. The article of manufacture of claim 26 wherein the unique identification numbers are pre-printed on the mailers.

29. The article of manufacture of claim 22 wherein the computer-executable instructions perform a method further comprising:
(d) providing an article commerce site that allows entities who possess articles to transact business with entities who desire to receive the articles; and
(e) the article commerce site communicating completed transactions to the shipment control entity so as to facilitate the shipping of the transacted articles among the entities.

30. The article of manufacture of claim 29 wherein the article commerce site and the shipment control entity are part of the same business entity.

31. The article of manufacture of claim 22 wherein the computer-executable instructions perform a method further comprising:
(d) the shipment control entity sending an electronic instruction message to the entity who possesses the article to ship the article to the entity who will receive the article, the electronic instruction message including a shipping address of the entity who will receive the article.

32. The article of manufacture of claim 22 wherein the shipment control entity is a hosting entity for a plurality of members of a common community that facilitates article trading among the members, and the plurality of entities who possess articles to ship and the plurality of entities who receive the articles are all members of the hosting entity.

33. The article of manufacture of claim 22 wherein step (c) further comprises the shipment control entity electronically paying the mail system for the shipping costs.

34. The article of manufacture of claim 22 wherein step (c) further comprises the shipment control entity electronically billing the shipping costs to either the entity that shipped the article or the entity that received the article.

35. The article of manufacture of claim 22 wherein the articles are compact discs.

36. The article of manufacture of claim 22 wherein the information in step (a) is an electronic message sent to the shipment control entity by the entity who possesses and will ship the article.

37. The article of manufacture of claim 22 wherein the plurality of entities who possess articles are merchants who have merchant accounts, and step (c) further comprises the shipment control entity authorizing payment to the mail system from the merchant account of the merchant that shipped the article.

38. The article of manufacture of claim 22 wherein the article attributes include the weight of the articles, and step (b) includes using at least the article weight to determine the article shipping cost.

39. The article of manufacture of claim 22 wherein the article attributes include ancillary items associated with the article.

40. The article of manufacture of claim 22 wherein the mail system is a government-run postal service.

41. The article of manufacture of claim 22 wherein step (c) further comprises creating a manifest that identifies each shipped article and the respective article shipping costs, and periodically communicating the manifests to the mail system via an electronic message, wherein the payments initiated in step (c) are based on the article shipping costs listed in the manifests.

42. The article of manufacture of claim 22 wherein each article shipment includes a unique identification number, the method further comprising:
(d) the shipment control entity electronically communicating the article shipping costs determined in step (b) to the mail system along with the associated unique identification numbers for the respective shipped articles; and
(e) the mail system detecting article shipments that include the unique identification numbers, wherein step (c) further comprises the mailing system charging the article shipping costs previously communicated to it in step (d) to the shipment control entity.
